(19) United States
(12) Patent Application Publication
(10) Pub. No.: US 2024/0004351 A1
(43) Pub. Date: Jan. 4, 2024

(54) Time Calibration Method, Electronic Device and Storage Medium

(71) Applicant: Apollo Intelligent Driving Technology (Beijing) Co., Ltd., Beijing (CN)

(72) Inventor: Rui DAI, Beijing (CN)

(21) Appl. No.: 18/093,096

(22) Filed: Jan. 4, 2023

(30) Foreign Application Priority Data
Jun. 29, 2022 (CN) 202210751890.4

(51) Int. Cl. G04R 20/02

(52) U.S. Cl. CPC G04R 20/02

(57) ABSTRACT

The present disclosure provides a time calibration method, an electronic device, and a storage medium, and relates to the technical field of automatic driving. The method can include: determining a first observation error between first reference time point and first system time point; determining a second observation error between second reference time point and second system time point; determining a unit drift per second of the system to be calibrated based on the first system time point, the second system time point, the first observation error, and the second observation error; and calibrating the time of the system to be calibrated based on the unit drift per second.

### CROSS-REFERENCE TO RELATED APPLICATION

The present disclosure claims priority to Chinese patent application No. 202210751890.4, filed on Jun. 29, 2022, and titled “Time Calibration Method and Device, Electronic Device and Storage Medium”, the disclosure of which is hereby incorporated by reference in its entirety.

### TECHNICAL FIELD

The present disclosure relates to the technical field of automatic driving, in particular, to a time calibration method, an electronic device, and a storage medium.

### BACKGROUND

At present, an automatic driving system requires the time of each computing unit and the time of each sensor to be synchronized at a very small accuracy. More accurate time synchronization indicates an accurate computing result. A timing service of a current Global Positioning System (GPS) is carried out based on a Pulses Per Second (PPS) signal, that is, the system time point will be updated by the GPS at an integral second. However, the system time point is driven and maintained by a crystal oscillator of the system in a time period between two time synchronizations. The crystal oscillator will be affected by temperature and other factors, so there is a certain frequency drift, resulting in a large system drift per second.

### SUMMARY

According to one aspect of the present disclosure, a time calibration method is provided, including: determining a first observation error between first reference time point and first system time point, wherein the first reference time point and the first system time point are obtained by respectively observing time values of a reference time point system and a system to be calibrated at a first moment; determining a second observation error between second reference time point and second system time point, wherein the second reference time point and the second system time point are obtained by respectively observing time values of the reference time point system and the system to be calibrated at a second moment; determining a unit drift per second of the system to be calibrated based on the first system time point, the second system time point, the first observation error, and the second observation error; and calibrating the time of the system to be calibrated based on the unit drift per second.

According to another aspect of the present disclosure, a time calibration apparatus is provided, including: a first determining module, configured to determine a first observation error between first reference time point and first system time point, wherein the first reference time point and the first system time point are obtained by respectively observing time values of a reference time point system and a system to be calibrated at a first moment; a second determining module, configured to determine a second observation error between second reference time point and second system time point, wherein the second reference time point and the second system time point are obtained by respectively observing time values of the reference time point system and the system to be calibrated at a second moment; a third determining module, configured to determine a unit drift per second of the system to be calibrated based on the first system time point, the second system time point, the first observation error, and the second observation error; and a calibration module, configured to calibrate the time of the system to be calibrated based on the unit drift per second.

According to a yet another aspect of the present disclosure, an electronic device is provided, including: at least one processor; and a memory in communication connection with the at least one processor, wherein the memory stores instructions executable by the at least one processor, the instructions are executed by the at least one processor to cause the at least one processor to be able to implement the time calibration method provided by the present disclosure.

According to still another aspect of the present disclosure, a non-transitory computer-readable storage medium storing computer instructions is provided, wherein the computer instructions are used for enabling a computer to implement the time calibration method provided by the present disclosure.

According to yet still another aspect of the present disclosure, a computer program product is provided, including a computer program, when executed by a processor, the computer program implements the time calibration method provided by the present disclosure.

It should be understood that the content described in this section is not intended to identify key or important features of the embodiments of the present disclosure, nor is it intended to limit the scope of the present disclosure. Other features of the present disclosure will be easily understood through the following specification.

### BRIEF DESCRIPTION OF THE DRAWINGS

The accompanying drawings are used for better understanding of this solution, and do not constitute a limitation to the present disclosure. In the drawings:

FIG. 1 is a schematic diagram of a time synchronization problem provided according to an embodiment of the present disclosure;

FIG. 2 is a flow chart of a time calibration method provided according to an embodiment of the present disclosure.

FIG. 3 is a flow chart of another time calibration method provided according to an embodiment of the present disclosure.

FIG. 4 is a structural block diagram of a time calibration apparatus provided according to an embodiment of the present disclosure.

### DETAILED DESCRIPTION

Exemplary embodiments of the present disclosure are described below with reference to the accompanying drawings, which include various details of the embodiments of the present disclosure to facilitate understanding and should be considered as exemplary only. Accordingly, those of ordinary skill in the art will recognize that various changes and modifications of the embodiments described herein can be made without departing from the scope and spirit of the present disclosure. Also, descriptions of well-known functions and structures are omitted from the following description for clarity and conciseness.

It should be noted that the terms “first”, “second”, and the like in the specification and claims of the present disclosure and the above drawings are used to distinguish similar objects, and do not have to be used to describe a specific order or sequence. It should be understood that the data used in this way are interchangeable under appropriate circumstances so that the embodiments of the present disclosure described herein can be implemented in an order other than those illustrated or described herein. In addition, the terms “include” and “have” as well as any of their variations are intended to cover non-exclusive inclusions. For example, processes, methods, systems, products, or devices that include a series of steps or units are not necessarily limited to those steps or units clearly listed below, but may include other steps or units that are not clearly listed or are inherent to these processes, methods, products, or devices.

An automatic driving system requires the time of each computing unit and the time of each sensor to be synchronized at a very small accuracy (usually a drift per second is less than 1 ms). More accurate time synchronization indicates an accurate computing result, and provides a higher-credibility computing result for an automatic driving upper software module. Timing service synchronization of a GPS is carried out based on a PPS signal, that is, synchronization is achieved every second. Therefore, the system time point will be updated by the GPS time at an integral second to obtain accurate time. However, the system time point is driven and maintained by a crystal oscillator of the system in a time period between the two time synchronizations. The crystal oscillator will be affected by temperature and other factors, so there is a certain frequency drift. Therefore, the system time point will have a cumulative drift over time within this time period.

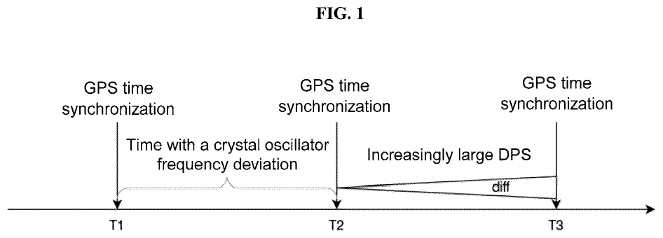

At present, in order to reduce the impact of the drift, a system designer will generally consider a maximum acceptable drift of the system time point and a system load caused by the periodic drift correction of a time update program to formulate a time update cycle, such as update every 60 seconds or every 10 seconds. Therefore, the disadvantage of this solution is that the system time point between two updates is inaccurate and is affected by the frequency offset of the crystal oscillator. The drift of the system time point will be larger if it is closer to a next time update moment. FIG. 1 is a schematic diagram of a time synchronization problem provided according to an embodiment of the present disclosure. A drift per second between T2 and T3 will become increasingly larger over time, and will be reduced until next GPS time synchronization, but there is no way to eliminate the drift between T2 and T3.

The present disclosure provides a time calibration method, which can calculate a drift per second introduced by a clock crystal oscillator, and take the drift per second as a calculation compensation, so that a system can provide long-term and accurate time synchronization.

According to an embodiment of the present disclosure, a time calibration method is provided. It should be noted that the steps shown in the flow chart of the drawings may be executed in a computer system with a group of computer-executable instructions, for example. In addition, although a logic order is shown in the flow chart, in some cases, the steps shown or described can be executed in an order different from that herein.

The method embodiment provided in the embodiment of the present disclosure can be implemented in a mobile terminal, a computer terminal or a similar electronic device. The electronic device aims to represents various types of digital computers, such as a laptop computer, a desktop computer, a workstation, a personal digital assistant, a server, a blade server, a mainframe computer, and other suitable computers. The electronic device may also represent various forms of mobile devices, such as a personal digital processor, a cellular phone, a smart phone, a wearable device, and other similar computing devices. The components shown herein, their connections and relationships, and their functions are merely examples, and are not intended to limit the implementation of the present disclosure described and/or required herein.

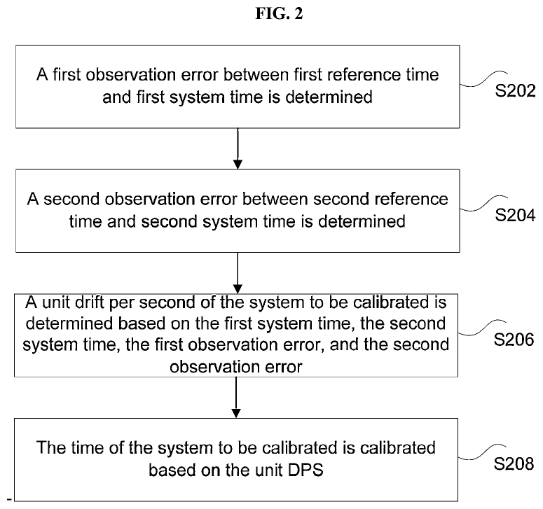

FIG. 2 is a flow chart of a time calibration method provided according to an embodiment of the present disclosure. As shown in FIG. 2, the method may include the following steps.

Step S202, a first observation error between first reference time point and first system time point is determined.

The first reference time point and the first system time point are obtained by respectively observing time values of a reference time point system and a system to be calibrated at a first moment.

The above-mentioned first moment may be a current moment, or may be any moment.

The above-mentioned reference time point system may be a satellite reference time point system, a GPS, a global navigation satellite system, a base station reference time point system, a wireless network reference time point system, a Beidou reference time point system, and the like.

The above-mentioned first reference time point may be a time point obtained by observing the reference time point system. Optionally, the time point of the reference time point system may be invoked using an invoking interface, thus obtaining the first reference time point to achieve a purpose of observing the time point of the reference time point system.

The above-mentioned system to be calibrated may be a system to be calibrated of an autonomous vehicle; the above-mentioned system to be calibrated may be a system to be calibrated of a computer; and the above-mentioned system to be calibrated may be a system to be calibrated of a mobile terminal.

The above-mentioned first system time point may be a time point obtained by observing the system to be calibrated. Optionally, the time point of the system to be calibrated may be invoked using the invoking interface, thus obtaining the first system time point to achieve a purpose of observing the time point of the system to be calibrated.

The above-mentioned first observation error may be an observation error between the first reference time point and the first system time point, and is used for representing an error generated by the system to be calibrated relative to the reference time point system at the first moment.

In one optional embodiment, the first observation error between the first reference time point and the first system time point may be determined, so that the system time point of the system to be calibrated is subsequently calibrated according to the first observation error, so as to obtain more accurate system time point.

In another optional embodiment, the first observation error between the first reference time point and the first system time point may be periodically determined, and the first observation error between the first reference time point and the first system time point may also be obtained according to a preset moment.

In yet another optional embodiment, a plurality of system time points within a period of time may be collected first, and the above-mentioned first system time point may be obtained by preprocessing the plurality of system time points. Optionally, the preprocessing manner may be calculating an average value of the plurality of system time points. The average value may be used as the above-mentioned first system time point. The preprocessing manner may also be selecting the system time point with a relatively small error from the plurality of system time points. The time point is used as the above-mentioned first system time point. The system time point extracted for the first time within a period of time may also be used as the above-mentioned first system time point, or the system time point extracted at last in a period of time may be used as the above-mentioned first system time point. The manner for extracting the second system time point may be the same as the manner for extracting the first system time point, and details will not be described later. Optionally, a manner for acquiring the first system time point may be set according to a specific application scenario of the system to be calibrated.

Step S204, a second observation error between second reference time point and second system time point is determined.

The second reference time point and the second system time point are obtained by respectively observing time values of the reference time point system and the system to be calibrated at a second moment.

The above-mentioned second reference time point and second system time point may be time points obtained after the first reference time point and the first system time point are obtained.

The above-mentioned second moment may be a moment after the first moment. There may be a preset time period between the second moment and the first moment. The second moment may be any moment after the first moment.

The above-mentioned second observation error may be an observation error between the second reference time point and the second system time point, and is used for representing an error generated by the system to be calibrated relative to the reference time point system at the second moment.

In one optional embodiment, a time value of a GPS may be observed to obtain the above-mentioned second reference time point, so as to calibrate the system time point of the system to be calibrated according to the second reference time point.

In one optional embodiment, the second reference time point and the second system time point may be determined at the second moment after the first moment, or the second observation error between the second reference time point and the second system time point may be acquired according to a preset moment. The first moment and the second moment may be adjacent moments, and the first moment and the second moment may also be moments separated by preset time.

In another optional embodiment, the first moment and the second moment may be flexibly set according to a specific scenario.

Step S206, a unit drift per second of the system to be calibrated is determined based on the first system time point, the second system time point, the first observation error, and the second observation error.

The above-mentioned unit drift per second may be a Drift Per Second (DSP) introduced by the crystal oscillator every second. The unit DSP may be a DSP introduced by the clock crystal oscillator of the system to be calibrated in the positioning process.

The above-mentioned system to be calibrated may be an entire automatic driving system of a vehicle, which may include a computing unit and various sensors, but is not limited to this.

In one optional embodiment, the system to be calibrated may use a clock crystal oscillator for timing. In the process of timing by the clock crystal oscillator, some DPSs will be introduced.

In one optional embodiment, a first variable and a second variable may be set. The first variable is the unit DSP, and the second variable is the fixed variable. A first equation set may be constructed according to the first variable, the first system time point, the second variable, and the first observation error; a second equation set may be constructed according to the first variable, the second system time point, the second variable, and the second observation error. The first equation set and the second equation set may be solved to obtain solutions of the first variable and the second variable. Thus, the above-mentioned unit DPS is obtained.

The above-mentioned fixed variable may represent a fixed time overhead of a software program introduced for the observation, such as, an overhead introduced by the invocation of the system time point and the reference time point through the interface.

Step S208, the time of the system to be calibrated is calibrated based on the unit DPS.

In one optional embodiment, the time of the system to be calibrated may be calibrated according to the unit DPS to obtain calibrated target system time point. The target system time point is used in the calculation process of the system to be calibrated.

In one optional embodiment, after the current system time point of the system to be calibrated is invoked, a difference value between the current system time point and historical system time point when the system is updated last time may be acquired, and compensation time is obtained according to a product of the difference value and the unit DPS; and the compensation time may be superimposed on the current system time point to calibrate the current system time point, thus obtaining the calibrated target system time point.

Further, after the target system time point is obtained, the system to be calibrated can use the target system time point for calculation, so as to improve the overall time accuracy of the system to be calibrated, thereby improving the processing accuracy of the system to be calibrated.

In another optional embodiment, the system time point of the system to be calibrated may be calibrated repeatedly using the unit DPS. The unit DPS may also be solved periodically, and the system time point of the system to be calibrated may be calibrated according to the obtained unit DPS. The unit DPS may also be solved according to preset time, and the system time point of the system to be calibrated may be calibrated according to the obtained unit DPS.

By means of the above-mentioned steps, a first observation error between first reference time point and first system time point is first determined, wherein the first reference time point and the first system time point are obtained by respectively observing time values of a reference time point system and a system to be calibrated at a first moment; a second observation error between second reference time point and second system time point is determined, wherein the second reference time point and the second system time point are obtained by respectively observing time values of the reference time point system and the system to be calibrated at a second moment; a unit drift per second of the system to be calibrated is determined based on the first system time point, the second system time point, the first observation error, and the second observation error; and the time of the system to be calibrated s calibrated based on the unit drift per second. Therefore, a dynamic unit drift per second is obtained and maintained through calculation, and the current system time point is corrected and compensated according to the unit drift per second, so that the impact of a frequency drift of a crystal oscillator on the current system time point is avoided; the accuracy of a microsecond scale can be maintained for quite long time; the accuracy of the system time point is improved; and the technical problem of the relatively large drift per second in the related art is solved.

Optionally, the step that the time of the system to be calibrated is calibrated based on the unit DPS includes: a target duration between the historical system time point and the current system time point is acquired, wherein the historical system time point is system time point corresponding to historical calibration of the system to be calibrated; target compensation time is determined based on the unit DPS and the target duration; and the time of the system to be calibrated is calibrated based on the target compensation time.

The above-mentioned historical system time point may be system time point corresponding to the previous calibration of the system to be calibrated.

The above-mentioned target compensation time is used for compensating a crystal oscillator drift of the system to be calibrated.

In one optional embodiment, the above-mentioned target duration may be determined according to a difference value between the current system time point and the historical system time point; the target compensation time may be determined according to a product of the unit DPS and the target duration; and the target system time point may be obtained according to the target compensation time and the current system time point.

Through the above steps, the current system time point can be calibrated by periodically calculating the target compensation time, so as to obtain more accurate target system time point.

Optionally, the step that the unit DPS of the system to be calibrated is determined based on the first system time point, the second system time point, the first observation error, and the second observation error includes: a first expression is constructed based on the first system time point, a first drift variable, a fixed variable, and the first observation error, wherein the first drift variable is a DPS introduced by a clock crystal oscillator of the system to be calibrated in a positioning process; a second expression is constructed based on the second system time point, the first drift variable, the fixed variable, and the second observation error; and the first expression and the second expression are solved to obtain the unit DPS.

The above-mentioned first system time point may be Tsys1. The first reference time point may be Tgps1. The above-mentioned first observation error may be Tdiff1, where Tdiff1=Tgps1−Tsys1.

The above-mentioned first drift variable may be DPS, which is used for representing the drift per second introduced by the clock crystal oscillator of the system to be calibrated in the positioning process.

The above-mentioned fixed variable may be a, which is used for representing the fixed time overhead of a software program introduced for the observation of the system time point.

The above-mentioned first expression may be DPS*Tsys1+a=Tdiff1.

The above-mentioned second system time point may be Tsys2. The second reference time point may be Tgps2. The above-mentioned second observation error may be Tdiff1, where Tdiff2=Tgps2−Tsys2.

The above-mentioned second expression may be DPS*Tsys2+a=Tdiff2.

$$\{ \begin{matrix}DPS * Tsys 1 + a = Tdiff 1 \\ DPS * Tsys 2 + a = Tdiff 2\end{matrix}$$

may be solved to obtain the DPS, that is, the solution corresponding to the above-mentioned DPS.

Through the above steps, the dynamic DPS can be calculated and maintained, and the system time point can be corrected and compensated according to a frequency drift rate, so that the impact of a frequency drift of a crystal oscillator on the system time point can be avoided; and the accuracy of a microsecond scale can be maintained for long time.

Optionally, the step that the target compensation time is determined based on the unit DPS and the target duration includes: the target compensation time is determined based on a product of the unit DPS and the target duration.

The above-mentioned target duration can be obtained by T-LU, where T is the system time point when the system to be calibrated is invoked, and LU is a moment when the system to be calibrated is updated last time.

The above-mentioned unit DPS is a solution value of DPS.

The above-mentioned target compensation time may be Tcomp, where Tcomp=(T-LU)*DPS.

In one optional embodiment, Tcomp may be used repeatedly, or Tcomp may be acquired periodically, or Tcomp may be obtained each time the system time point of the system to be calibrated is calibrated.

Through the above steps, the current system time point can be calibrated through the target compensation time after the current system time point of the system to be calibrated is invoked, thus obtaining the more accurate target system time point, and the system time point of the system to be calibrated can be updated according to the target system time point.

Optionally, the step that the time of the system to be calibrated is calibrated based on the target compensation time includes: calibration is performed based on a sum value of the target compensation time and the time of the system to be calibrated.

In one optional embodiment, the target compensation time can be directly superimposed on the current system time point to obtain the target system time point, so that the target system time point can ensure that the system to be calibrated can be accurate enough for a long time.

Optionally, the fixed variable is used for representing the time overhead introduced during the observation of the time of the reference time point system or the time of the system to be calibrated.

The above-mentioned fixed variable can be the time overhead on the software program introduced by invoking, through an interface, the time of the reference time point system or the time of the system to be calibrated.

Through the above-mentioned content of the present disclosure, an accuracy loss caused by a temperature drift of a crystal oscillator device can be calculated on a time-sensitive system, and is compensated and corrected through calculation to ensure that the system time point is sufficiently accurate for a long time. Through a GPS time service and system measurement, the DPS introduced by the crystal oscillator of the system is calculated; and the system time point is compensated using a drift of the crystal oscillator of the system, thus obtaining the more accurate system time point.

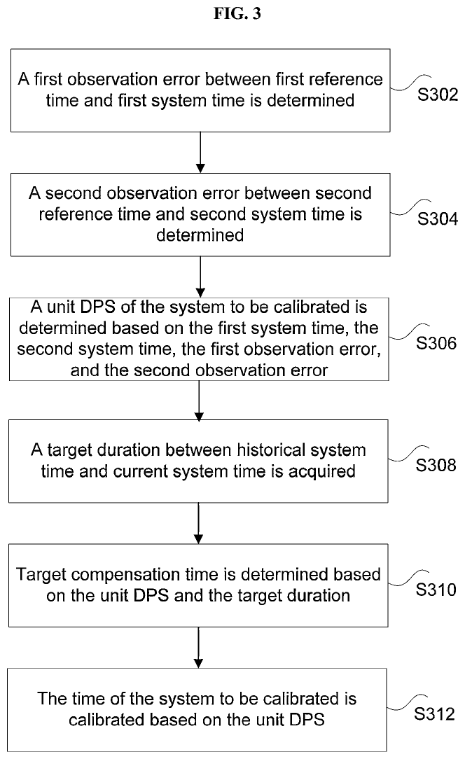

FIG. 3 is a flow chart of another time calibration method provided according to an embodiment of the present disclosure. As shown in FIG. 3, the method may include the following steps.

Step S302, a first observation error between first reference time point and first system time point is determined, wherein the first reference time point and the first system time point are obtained by respectively observing time values of a reference time point system and a system to be calibrated at a first moment.

Step S304, a second observation error between second reference time point and second system time point is determined, wherein the second reference time point and the second system time point are obtained by respectively observing time values of the reference time point system and the system to be calibrated at a second moment.

Step S306, a unit DPS of the system to be calibrated is determined based on the first system time point, the second system time point, the first observation error, and the second observation error.

Step S308, a target duration between historical system time point and current system time point is acquired, wherein the historical system time point is system time point corresponding to historical calibration of the system to be calibrated.

Step S310, target compensation time is determined based on the unit DPS and the target duration.

Step S312, the time of the system to be calibrated is calibrated based on the unit DPS.

In the technical solutions of the present disclosure, the acquisition, storage, use, processing, transmission, providing, disclosure and the like of user's personal information involved are all in compliance with the provisions of relevant laws and regulations, and do not violate public order and good customs.

Through the description of the above implementations, those skilled in the art can clearly understand that the method according to the above embodiment can be implemented by means of software and necessary general hardware platforms, of course, it can also be implemented by hardware, but in many cases, the former is better. Based on this understanding, the technical solution of the present disclosure essentially or the part that contributes to the existing art can be embodied in the form of a software product, and the computer software product is stored in one storage medium and includes several instructions to enable a terminal device (which can be a mobile phone, a computer, a server, or a network device, etc.) to execute the methods described in the various embodiments of the present disclosure.

A time calibration apparatus is further provided in the present disclosure. The apparatus is configured to achieve the above embodiments and preferred implementations. Those described will not be repeatedly described. As used below, the term “module” can implement a combination of software and/or hardware with predetermined functions. Although the apparatuses described in the following embodiments are preferably implemented by software, implementation by hardware or a combination of software and hardware is also possible and contemplated.

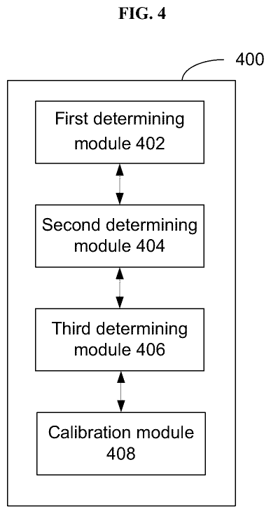

FIG. 4 is a structural block diagram of a time calibration apparatus provided according to an embodiment of the present disclosure. As shown in FIG. 4, the time calibration apparatus 400 includes a first determining module 402, a second determining module 404, a third determining module 406, and a calibration module 408.

The first determining module is configured to determine a first observation error between first reference time point and first system time point, wherein the first reference time point and the first system time point are obtained by respectively observing time values of a reference time point system and a system to be calibrated at a first moment; the second determining module is configured to determine a second observation error between second reference time point and second system time point, wherein the second reference time point and the second system time point are obtained by respectively observing time values of the reference time point system and the system to be calibrated at a second moment; the third determining module is configured to determine a unit DPS of the system to be calibrated based on the first system time point, the second system time point, the first observation error, and the second observation error; and a calibration module, configured to calibrate the time of the system to be calibrated based on the unit DPS.

Optionally, the calibration module includes a first acquisition unit, a first determining unit, and a calibration unit.

The first acquisition unit is configured to acquire a target duration between the historical system time point and the current system time point, wherein the historical system time point is system time point corresponding to historical calibration of the system to be calibrated; the first determining unit is configured to determine target compensation time based on the unit DPS and the target duration; and the calibration unit is configured to calibrate the time of the system to be calibrated based on the target compensation time.

Optionally, the third determining module includes a first construction unit, a second construction unit, and a solving unit.

The first construction unit is configured to construct a first expression based on the first system time point, a first drift variable, a fixed variable, and the first observation error, wherein the first drift variable is a DPS introduced by a clock crystal oscillator of the system to be calibrated in a positioning process; the second construction unit is configured to construct a second expression based on the second system time, the first drift variable, the fixed variable, and the second observation error; and the solving unit is configured to solve the first expression and the second expression to obtain the unit DPS.

Optionally, the first determining unit is further configured to determine the target compensation time based on a product of the unit DPS and the target duration.

Optionally, the calibration unit is further configured to perform calibration based on a sum value of the target compensation time and the time of the system to be calibrated.

Optionally, the fixed variable is used for representing the time overhead introduced during the observation of the time of the reference time point system or the time of the system to be calibrated.

It should be noted that all the above modules can be implemented by software or hardware. For the latter, they can be implemented by the following methods, but are not limited to this. The above-mentioned modules are all located in a same processor, or all the above-mentioned modules are respectively located in different processors in any combination form.

According to an embodiment of the present disclosure, the present disclosure further provides an electronic apparatus, including a memory and at least one processor. The memory stores a computer program. The processor is configured to run the computer program to execute the steps in any one of the above-mentioned method embodiments.

Optionally, the above-mentioned electronic device may further include a transmission device and an input/output device. The transmission device is connected to the above-mentioned processor, and the input/output device is connected to the above-mentioned processor.

Optionally, in the present disclosure, the above-mentioned processor may be configured to execute the following steps through a computer program:

S1, determining a first observation error between first reference time point and first system time point, wherein the first reference time point and the first system time point are obtained by respectively observing time values of a reference time point system and a system to be calibrated at a first moment;

S2, determining a second observation error between second reference time point and second system time point, wherein the second reference time point and the second system time point are obtained by respectively observing time values of the reference time point system and the system to be calibrated at a second moment;

S3, determining a unit drift per second of the system to be calibrated based on the first system time point, the second system time point, the first observation error, and the second observation error; and

S4, calibrating the time of the system to be calibrated based on the unit drift per second.

Optionally, for specific examples in this embodiment, reference may be made to the examples described in the foregoing embodiments and optional implementations, and details are not described herein again in this embodiment.

According to an embodiment of the present disclosure, the present disclosure further provides a non-transitory computer-readable storage medium storing computer instructions. The non-transitory computer-readable storage medium stores the computer instructions. The computer instructions, when run, are configured to execute the steps in any one of the above-mentioned method embodiments.

Optionally, in this embodiment, the above-mentioned non-volatile storage medium may be configured to store a computer program used for executing the following steps:

S1, determining a first observation error between first reference time point and first system time point, wherein the first reference time point and the first system time point are obtained by respectively observing time values of a reference time point system and a system to be calibrated at a first moment;

S2, determining a second observation error between second reference time point and second system time point, wherein the second reference time point and the second system time point are obtained by respectively observing time values of the reference time point system and the system to be calibrated at a second moment;

S3, determining a unit drift per second of the system to be calibrated based on the first system time point, the second system time point, the first observation error, and the second observation error; and

S4, calibrating the time of the system to be calibrated based on the unit drift per second.

Optionally, in this embodiment, the above-mentioned non-transitory computer-readable medium may include, but is not limited to, an electronic, magnetic, optical, electromagnetic, infrared, or semiconductor system, apparatus, or device, or any suitable combination of the above contents. More specific examples of the readable storage medium would include an electrical connection based on one or more wires, a portable computer disk, a hard disk, a random access memory (RAM), a read only memory (ROM), an erasable programmable read-only memory (EPROM or flash memory), an optical fiber, a portable compact disk read-only memory (CD-ROM), an optical storage device, a magnetic storage device, or any suitable combination of the above.

According to an embodiment of the present disclosure, the present disclosure further provides a computer program product. Program codes used for implementing the method embodiments of the present disclosure can be written in any combination of one or more programming languages. These program codes can be provided to processors or controllers of general-purpose computers, special-purpose computers, or other programmable data processing apparatuses, so that when the program codes are executed by the processor or controller, the functions specified in the flow charts and/or block diagrams are implemented. The program codes can be entirely or partly executed on the machine, partly executed on the machine as an independent software package, and partly executed on a remote machine, or entirely executed on the remote machine or a server.

In the above-mentioned embodiments of the present disclosure, the descriptions of all the embodiments have their own focuses. For parts that are not described in detail in an embodiment, reference may be made to related descriptions of other embodiments.

In the several embodiments provided by the present disclosure, it should be understood that the disclosed technical contents may be implemented in other manners. The apparatus embodiment described above is merely illustrative. For example, the division of units may be a logical function division. In actual implementation, there may be other division methods. For example, multiple units or components may be combined or integrated into another system, or some features can be ignored, or not executed. From another point of view, the mutual coupling or direct coupling or communication connection shown or discussed may be indirect coupling or communication connection through some interfaces, units or modules, and may be in electrical or other forms.

The units described as separate components may or may not be physically separated, and the components displayed as units may or may not be physical units, that is, they may be located in one place, or they may be distributed on multiple units. Part or all of the units may be selected according to actual needs to achieve the objectives of the solutions of the embodiments.

In addition, all functional units in all the embodiments of the present disclosure can be integrated into one processing unit, or each unit can physically exist alone, or two or more units can be integrated in one unit. The above integrated units can be implemented in the form of hardware, or can be implemented in the form of software functional units.

The integrated unit, if implemented in the form of a software functional unit and sold or used as a standalone product, may be stored in a computer readable storage medium. Based on this understanding, the technical solutions of the present disclosure essentially or parts that contribute to the existing technology or all or part of the technical solutions can be embodied in the form of a software product, and the computer software product is stored in a storage medium, including several instructions used to cause a computer device (which can be a personal computer, a server, or a network device, etc.) to execute all or part of the steps of the methods in the various embodiments of the present disclosure. The aforementioned storage media include: a USB flash disk, a ROM, a RAM, a mobile disk, a magnetic disk or an optical disk, and other media that can store program codes.

The above describes some embodiments of the present disclosure. It should be noted that those of ordinary skill in the art can further make several improvements and retouches without departing from the principles of the present disclosure. These improvements and retouches shall all fall within the protection scope of the present disclosure.

What is claimed is:

1. A time calibration method, comprising:
determining a first observation error between a first reference time point and a first system time point, wherein the first reference time point and the first system time point are obtained by respectively observing time values of a reference time point system and a system to be calibrated at a first moment;
determining a second observation error between a second reference time point and a second system time point, wherein the second reference time point and the second system time point are obtained by respectively observing time values of the reference time point system and the system to be calibrated at a second moment;
determining a unit drift per second of the system to be calibrated based on the first system time point, the second system time point, the first observation error, and the second observation error; and
calibrating the time value of the system to be calibrated based on the unit drift per second.

2. The method as claimed in claim 1, wherein calibrating the time value of the system to be calibrated based on the unit drift per second comprises:
acquiring a target duration between historical system time point and current system time point, wherein the historical system time point is system time point corresponding to historical calibration of the system to be calibrated;
determining target compensation time based on the unit drift per second and the target duration; and
calibrating the time value of the system to be calibrated based on the target compensation time.

3. The method as claimed in claim 1, wherein determining the unit drift per second of the system to be calibrated based on the first system time point, the second system time point, the first observation error, and the second observation error comprises:
constructing a first expression based on the first system time point, a first drift variable, a fixed variable, and the first observation error, wherein the first drift variable is a drift per second introduced by a clock crystal oscillator of the system to be calibrated in a positioning process;
constructing a second expression based on the second system time point, the first drift variable, the fixed variable, and the second observation error; and
solving the first expression and the second expression to obtain the unit drift per second.

4. The method as claimed in claim 2, wherein determining the target compensation time based on the unit drift per second and the target duration comprises:
determining the target compensation time based on a product of the unit drift per second and the target duration.

5. The method as claimed in claim 2, wherein calibrating the time value of the system to be calibrated based on the target compensation time comprises:
performing calibration based on a sum value of the target compensation time and the time value of the system to be calibrated.

6. The method as claimed in claim 3, wherein the fixed variable is used for expressing a time overhead introduced during observation of the time of the reference time point system or the time value of the system to be calibrated.

7. The method as claimed in claim 1, wherein the reference time point of the reference time system and the first system time point of the system to be calibrated are invoked using an invoking interface.

8. The method as claimed in claim 1, wherein the first moment and the second moment are moments separated by preset time.

9. An electronic device, comprising:
at least one processor; and
a memory in communication connection with the at least one processor, wherein the memory stores instructions executable by the at least one processor, the instructions when executed by the at least one processor, cause the at least one processor to implement a method comprising:
determining a first observation error between a first reference time and a first system time, wherein the first reference time and the first system time are obtained by respectively observing time values of a reference time system and a system to be calibrated at a first moment;
determining a second observation error between a second reference time and a second system time, wherein the second reference time and the second system time are obtained by respectively observing time values of the reference time system and the system to be calibrated at a second moment;
determining a unit drift per second of the system to be calibrated based on the first system time, the second system time, the first observation error, and the second observation error; and
calibrating the time value of the system to be calibrated based on the unit drift per second.

10. The electronic device as claimed in claim 9, wherein the method comprises:
acquiring a target duration between historical system time point and current system time point, wherein the historical system time point is system time point corresponding to historical calibration of the system to be calibrated;
determining target compensation time based on the unit drift per second and the target duration; and
calibrating the time value of the system to be calibrated based on the target compensation time.

11. The electronic device as claimed in claim 9, wherein the method comprises:
constructing a first expression based on a first system time point, a first drift variable, a fixed variable, and the first observation error, wherein the first drift variable is a drift per second introduced by a clock crystal oscillator of the system to be calibrated in a positioning process;
constructing a second expression based on a second system time point, the first drift variable, the fixed variable, and the second observation error; and
solving the first expression and the second expression to obtain the unit drift per second.

12. The electronic device as claimed in claim 10, wherein the method comprises:
determining the target compensation time based on a product of the unit drift per second and the target duration.

13. The electronic device as claimed in claim 10, wherein the method comprises:
performing calibration based on a sum value of the target compensation time and the time value of the system to be calibrated.

14. The electronic device as claimed in claim 11, wherein the fixed variable is used for expressing a time overhead introduced during observation of the time of a reference time point system or the time value of the system to be calibrated.

15. A non-transitory computer-readable storage medium storing computer instructions, wherein the computer instructions cause a computer to implement a method comprising:
determining a first observation error between a first reference time and a first system time, wherein the first reference time and the first system time are obtained by respectively observing time values of a reference time point system and a system to be calibrated at a first moment;
determining a second observation error between a second reference time and a second system time, wherein the second reference time and the second system time are obtained by respectively observing time values of the reference time system and the system to be calibrated at a second moment;
determining a unit drift per second of the system to be calibrated based on the first system time, the second system time, the first observation error, and the second observation error; and
calibrating the time value of the system to be calibrated based on the unit drift per second.

16. The non-transitory computer-readable storage medium as claimed in claim 15, wherein the method comprises:
acquiring a target duration between historical system time point and current system time point, wherein the historical system time point is system time point corresponding to historical calibration of the system to be calibrated;
determining target compensation time based on the unit drift per second and the target duration; and
calibrating the time value of the system to be calibrated based on the target compensation time.

17. The non-transitory computer-readable storage medium as claimed in claim 15, wherein the method comprises:
constructing a first expression based on a first system time point, a first drift variable, a fixed variable, and the first observation error, wherein the first drift variable is a drift per second introduced by a clock crystal oscillator of the system to be calibrated in a positioning process;
constructing a second expression based on a second system time point, the first drift variable, the fixed variable, and the second observation error; and
solving the first expression and the second expression to obtain the unit drift per second.

18. The non-transitory computer-readable storage medium as claimed in claim 16, wherein the method comprises:
determining the target compensation time based on a product of the unit drift per second and the target duration.

19. The non-transitory computer-readable storage medium as claimed in claim 16, wherein the method comprises:
performing calibration based on a sum value of the target compensation time and the time value of the system to be calibrated.

20. The non-transitory computer-readable storage medium as claimed in claim 17, wherein the fixed variable is used for expressing a time overhead introduced during observation of the time of the reference time point system or the time value of the system to be calibrated.
